(19) United States
(12) Patent Application Publication
(10) Pub. No.: US 2014/0098518 A1
(43) Pub. Date: Apr. 10, 2014

(54) DEVICE FOR THE BEAM SHAPING OF LIGHT

(71) Applicant: OSRAM GmbH, Muenchen (DE)

(72) Inventor: Henning Rehn, Berlin (DE)

(73) Assignee: OSRAM GmbH, Muenchen (DE)

(21) Appl. No.: 14/023,505

(22) Filed: Sep. 11, 2013

(30) Foreign Application Priority Data
Oct. 5, 2012 (DE) 102012218179.2

(51) Int. Cl. F21V 5/02

(52) U.S. Cl. CPC F21V 5/02
USPC 362/84; 362/339; 362/311.06

(57) ABSTRACT

In various embodiments, a device for the beam shaping of light is provided. The device may include: a solid body composed of a transmission material that is at least partly transmissive to the light, the solid body including: a coupling-in surface for coupling in the light, a first reflection surface for deflecting the light, and a coupling-out surface for coupling out the light, wherein the solid body is designed to reflect the coupled-in light in its interior at the first reflection surface; and wherein the first reflection surface is embodied in a parabolic fashion in a sectional plane including a propagation direction of the reflected light.

### CROSS-REFERENCE TO RELATED APPLICATION

This application claims priority to German Patent Application Serial No. 10 2012 218 179.2, which was filed Oct. 5, 2012, and is incorporated herein by reference in its entirety.

### TECHNICAL FIELD

Various embodiments relate to a device for the beam shaping of light (beam shaping device), which has a solid body composed of a transmission material that is at least partly transmissive to the light.

### BACKGROUND

In comparison with conventional incandescent lamps, light sources currently being developed are distinguished by an increased energy efficiency; one example thereof is light-emitting semiconductor components (LEDs), for instance inorganic light-emitting diodes based on GaAs (but also organic LEDs). The light emitted by the LED can either directly itself be used in an application or as pump light firstly excite a phosphor, which then emits converted light having a longer wavelength.

The emission characteristic of the LED, but also that of a phosphor element provided in an areal fashion, for example, can be described as Lambertian at least to a certain approximation, that is to say that, to put it in simplified terms, the luminous surface (of LED or phosphor) appears equally bright independently of the viewing direction; the emission takes place diffusely, that is to say non-directionally,

### SUMMARY

In various embodiments, a device for the beam shaping of light is provided. The device may include: a solid body composed of a transmission material that is at least partly transmissive to the light, the solid body including: a coupling-in surface for coupling in the light, a first reflection surface for deflecting the light, and a coupling-out surface for coupling out the light, wherein the solid body is designed to reflect the coupled-in light in its interior at the first reflection surface; and wherein the first reflection surface is embodied in a parabolic fashion in a sectional plane including a propagation direction of the reflected light.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the invention. In the following description, various embodiments of the invention are described with reference to the following drawings, in which:

FIG. 1 shows a beam shaping device in accordance with various embodiments in section;

FIG. 2 shows a beam shaping device in accordance with various embodiments in an oblique view;

FIG. 3 shows a beam shaping device with a multiplicity of solid bodies;

FIG. 4 shows a beam shaping device with a coupling-in surface offset relative to the focal point of the parabola; and

FIG. 5 shows , like FIG. 4, a beam shaping device with offset coupling-in surface.

### DESCRIPTION

The following detailed description refers to the accompanying drawings that show, by way of illustration, specific details and embodiments in which the invention may be practiced.

The word “exemplary” is used herein to mean “serving as an example, instance, or illustration”. Any embodiment or design described herein as “exemplary” is not necessarily to be construed as preferred or advantageous over other embodiments or designs.

The word “over” used with regards to a deposited material formed “over” a side or surface, may be used herein to mean that the deposited material may be formed “directly on”, e.g. in direct contact with, the implied side or surface. The word “over” used with regards to a deposited material formed “over” a side or surface, may be used herein to mean that the deposited material may be formed “indirectly on” the implied side or surface with one or more additional layers being arranged between the implied side or surface and the deposited material.

Various embodiments specify an advantageous device for the beam shaping of light.

Various embodiments provide a beam shaping device having a solid body composed of a transmission material that is at least partly transmissive to the light, said solid body having a coupling-in surface for coupling in the light, a first reflection surface for deflecting the light, and a coupling-out surface for coupling out the light; in this case, the solid body is designed to reflect the coupled-in light in its interior at the first reflection surface, and the first reflection surface is embodied in a parabolic fashion in a sectional plane (“in section” hereinafter for the sake of simplicity) including a propagation direction of the reflected light.

Via the coupling-in surface, therefore, by way of example, the light emitted by an LED directly and/or a phosphor element can be coupled into the solid body as a divergent beam and then propagates in said solid body (if appropriate with a different aperture angle, but nevertheless as a divergent beam). The divergent beam is then reflected at the reflection surface that is parabolic in section, and is at least approximately collimated in this case (in section) on account of the parabolic shape of the reflection surface.

The light subsequently emerges as (approximately, hereinafter not specifically emphasized anymore) collimated beam at the coupling-out surface and can be supplied to a further use; in this case, the reflection at the parabolic reflection surface need not necessarily take place directly “in the direction of the coupling-out surface”, rather the light downstream of the parabolic reflection surface and upstream of coupling-out can also be reflected again in the solid body (which is even preferred).

In general, the “parabolic” configuration is intended not necessarily to require a course that follows a parabola exactly. Alongside, for example, a deviation within the scope of customary manufacturing fluctuations, the first reflection surface can, for example, also be embodied in a manner subdivided into a multiplicity of partial surfaces, for instance faceted; the indication “parabolic” can therefore also refer to a line placed through the first reflection surface (in section) in the course of averaging. A “smooth” first reflection surface is nevertheless preferred. As viewed in the section, the solid body then lies “within” the parabola (with the focal point thereof on the same side); in other words, the solid body is embodied in a convex fashion at the first reflection surface.

When considered from an idealized point of view, the coupling-in surface, as viewed in section, can then run for example through the focal point of the parabola and at the focal point coupled-in, divergent light from an approximately punctiform light source is collimated by the reflection at the parabolic reflection surface; an inherently areal light source, for example a (rectangular, in particular square) LED having an edge length of one millimeter, can also be approximately “punctiform” if the solid body is correspondingly large in relation thereto.

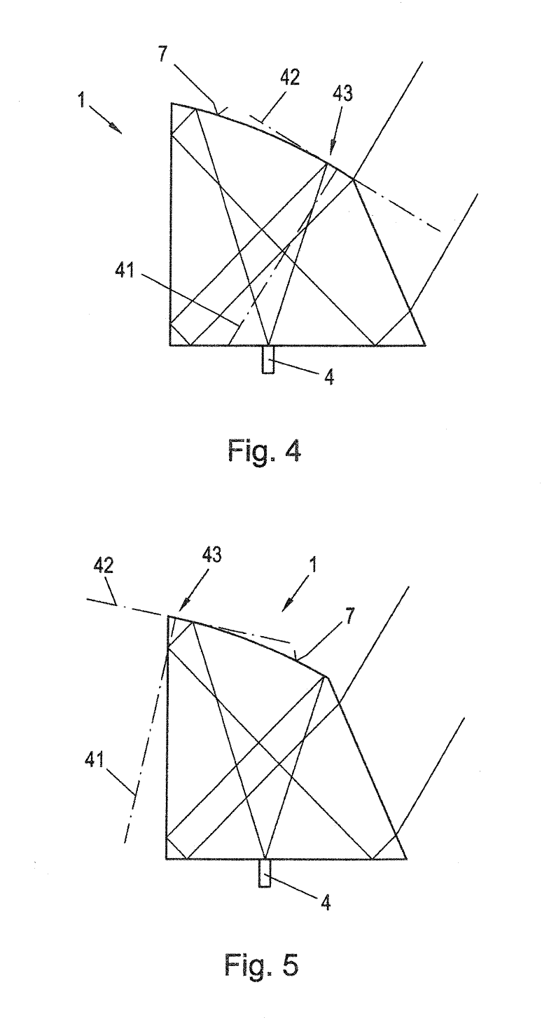

The inventor has additionally discovered that even a divergent beam coupled in somewhat offset with respect to the focal point can still be collimated sufficiently (cf. FIG. 4 and FIG. 5). The coupling-in nevertheless preferably takes place in a manner offset by not more than 50%, 25% or 10% of the focal length of the parabola with respect to its focal point.

Therefore, a beam emitted by an areal (and not even approximately punctiform) light source can also be coupled into the solid body and is collimated sufficiently therein. It is appropriate to talk of “areal” instead of “punctiform” when the light source (and/or a phosphor element), as viewed in section, has a width of, for example, at least 10%, 30% or 50% of the width of the first reflection surface.

In general, a multiplicity of sectional planes can include the propagation direction of the reflected light and the first reflection surface is intended to be embodied in a parabolic fashion in at least one of the possible sectional planes (if the beam is not perfectly collimated, the sectional plane may include a main propagation direction formed as an average value of propagation directions weighted according to the luminous flux).

In so far as reference is made to light propagation generally in the context of this disclosure, this is of course not intended to imply that light propagation also actually has to be effected in order to fulfill the subject matter; the device is merely intended to be designed for corresponding light propagation.

Various embodiments can be found in the dependent claims and in the following description; in this case, a distinction is not always made specifically between the presentation of the beam shaping device and a lighting device including such a beam shaping device or methods or uses in regard thereof; the features should at all events be implicitly understood as being disclosed in every respect.

In various embodiments, the first reflection surface is reflectively coated on the outer side; in the region of the first reflection surface, therefore, a thin layer, for instance composed of metal or a dielectric, or a multilayer system can be applied to the solid body for example on the outer side.

A reflective coating can be advantageous in so far as light incident on the first reflection surface is thus reflected independently of the angle of incidence (and the ratio of the refractive indexes of the solid body and of a surrounding medium) at the surface that is parabolic in section, that is to say that total reflection is not necessary. This may, for example, simplify the construction of the beam shaping device and, for example, enable a compact design.

If the light is intended to be reflected at the first reflection surface by total reflection (which in general is also possible), the light must be incident on the first reflection surface at an angle, >θ_{c}, that is to say in a corresponding “flat” fashion depending on the ratio of the refractive indexes of the solid body and of the surrounding medium. A minimum size y which the solid body, in particular the first reflection surface, must have in order to meet the condition of total reflection at the first reflection surface can be estimated for example approximately (disregarding the divergence of the beam and assuming that n_{surrounding medium}=1) by way of y≈f/(1−1/n²_{solid body}), where f is the focal length of the parabola.

In other words, the angle between the parabola axis and the divergent beam (a main propagation direction thereof) becomes large (usually significantly greater than 90°), which requires a correspondingly large solid body. If the first reflection surface is reflectively coated, however, said angle can also be chosen to be increasingly preferably in this order less than/equal to 90°, 80°, 70°, 60°, 50° or 45°.

The coupling-out surface is preferably embodied with an antireflective design, for example by giving continuity to refractive indexes or by extinction by means of interference; in other words, an antireflection coating can be provided on the solid body.

In various embodiments, the solid body has a second reflection surface, which is designed to reflect the coupled-in light without changing its concentration, to be precise preferably by total reflection, that is to say by virtue of the light being incident thereon at an angle >θ_{c} (in this case, the solid body has a higher refractive index than a surrounding medium, usually air).

It should be noted at this juncture (independently of the presence of the second reflection surface) that the beam shaping device can be “operated” in two directions, in principle, wherein reference was made previously to a divergent beam which propagates approximately from the focal point of the parabola toward the first reflection surface, which beam is collimated by the reflection at the first reflection surface. (00281 With the beam shaping device, however, a collimated beam can also be focused, to be precise equally by a reflection at the first reflection surface, which is parabolic in section. The light in the form of the collimated beam is coupled into the solid body via the coupling-in surface, is incident on the first reflection surface, e.g. at an angle of greater than/equal to 135° (increasingly preferably in this order greater than/equal to 145°, 155°, 165° or 175°) with respect to the parabola axis, and becomes a convergent beam as a result of the reflection.

A phosphor element arranged at the coupling-out surface, for example, can be illuminated with the convergent beam; the converted light can then be supplied at the opposite side thereof, for example, to a further use, for example for projection purposes. With the beam shaping device, therefore, pump light present as a collimated beam, for instance LASER light, can be focused by the reflection at the parabolic reflection surface to form a convergent beam, and the latter can be used to illuminate a phosphor element.

The conversion light emitted by the phosphor element operated in transmission at the opposite side relative to the beam shaping device can also be “gathered” by means of an optical unit, for example by means of a further beam shaping device.

In order to increase the luminous efficiency, the coupling-out surface of the beam shaping device that focuses the pump light onto the phosphor element can, for instance, also be dichroically reflectively coated, such that conversion light emitted in the direction of said coupling-out surface is reflected in the opposite direction (in the direction of an application, in particular a “gathering” optical unit). The phosphor element may, for example, also directly adjoin the coupling-out surface, such that the pump light does not have to penetrate through a further medium, which can help to reduce Fresnel losses.

The second reflection surface provided in a preferred configuration is provided (independently of the “use direction”) in the beam path for example where a collimated beam is present, namely downstream (relative to the propagation direction) of the first reflection surface in the case of collimating use and upstream of the first reflection surface in the case of focusing use. Reflecting a collimated beam may be advantageous in so far as the light is reflected at the second reflection surface preferably by total reflection and the condition for total reflection (angle of incidence>θ_{c}) is thus the same for all rays of the beam; this may, for example, simplify the construction of the beam shaping device.

Generally, as a result of the reflection at the first (parabolic) reflection surface, therefore, the concentration of the coupled-in light is altered, that is to say collimated or focused depending on the use, and the second reflection surface enables a (pure) deflection of the light. The latter may be advantageous for instance in so far as it can take account, for example, of the relative positioning of an LED and of an application that uses the light thereof, such that external optical components, for instance an external mirror, otherwise necessary, if appropriate, can be replaced.

In this respect, too, that is to say ultimately with regard to an overall compact design, and also regarding the total costs, preference is furthermore given to a solid body having a third reflection surface, at which the light is in turn reflected without altering its concentration, preferably by total reflection. (In so far as a solid body having a “first, second and third reflection surface” is mentioned in the context of this disclosure, this generally does not rule out the presence of further reflection surfaces, even though exactly three reflection surfaces may be provided.)

In the section relating to the parabolic configuration, the second reflection surface (the surface normal thereof) is tilted relative to the parabola axis by, e.g. in this order, at least 90°, 100°, 120° or 130° and (independently thereof), e.g. in this order, not more than 170°, 160°, 150° or 140° (also independently of the presence of a third reflection surface). The second reflection surface and (if provided) the third reflection surface are tilted, e.g. in this order, by at least 60°, 70° or 80° and (independently thereof), e.g. in this order, by at most 160°, 150°, 140°, 130°, 120°, 110°, or 100° with respect to one another; for example, they are perpendicular to one another.

For instance in the case of an LED or a phosphor element whose divergent light is collimated by means of the beam shaping device, the light after coupling-out on account of a “reversal of direction” by means of the reflection surfaces at all events can be emitted into the same half-space as the light before coupling-in; the beam shaping device can be placed onto the LED/phosphor element, and no external optical components need be provided “on the rear side” of the LED/phosphor element, which can be advantageous for instance also for space reasons.

A particularly preferred configuration of the solid body having a second and third reflection surface relates to a beam shaping device for the collimating use, wherein the second and third reflection surfaces are arranged downstream of the first reflection surface in a section of the beam path with a collimated beam, and wherein the coupling-in surface and the third reflection surface coincide.

The light is coupled in via the coupling-in surface, reflected at the first (parabolic) reflection surface and the second reflection surface and then reflected at the third reflection surface, which corresponds to the coupling-in surface, in the direction of the coupling-out surface, to be precise preferably directly (without further reflection). Since the light (coupled in previously) is totally reflected at the third reflection surface, no reflective coating is required at the third reflection surface and the latter can therefore simultaneously be used as the coupling-in surface, which is also of interest with regard to an overall compact design.

Second reflection surface and (if present) third reflection surface are, as already mentioned, e.g. arranged in the collimated beam; in the case of focusing use, the second reflection surface is therefore preferably disposed upstream of the first reflection surface and, if present, the third reflection surface is also disposed upstream of the first and additionally the second reflection surface (relative to the direction of light propagation, the order is then in other words “third, second and first” reflection surface). In the case of focusing use, the third reflection surface then e.g. coincides with the coupling-out surface.

The light to be focused therefore, with further preference, is totally reflected directly after coupling-in (without prior reflection) at the third reflection surface in ₜhe direction of the second and first reflection surfaces and is subsequently coupled out at the third reflection surface and illuminates, for example, a phosphor element arranged there (or at any way disposed downstream of the coupling-out surface in the beam path). (Such a phosphor element has already been described above, to be precise with regard to operation in transmission.)

With the beam shaping device according to various embodiments, however, the phosphor element may also be operated in reflection, that is to say that the phosphor element can be illuminated with pump light from one side and converted light can be guided away at the seam side (both by means of the beam shaping device); this can be advantageous, for instance, in so far as then the opposite rear side of the phosphor element is “free” and can be cooled, for example, by means of, for example, a heat sink that ideally reflects pump light and conversion light.

Therefore, pump light is coupled out via the coupling-out surface assigned to the phosphor element, and conversion light emitted by the phosphor element is coupled in via the same surface (the coupling-out surface is simultaneously the coupling-in surface). The conversion light in the form of a divergent beam is collimated at the first reflection surface, which is parabolic in section; in addition, the first reflection surface focuses the pump light coupled in as a collimated beam in the opposite direction, that is to say in the direction of the coupling-out surface (for the pump light) or coupling-in surface (for the conversion light).

In addition, pump light and conversion light are (totally) reflected, if present, at second and third reflection surfaces, to be precise preferably the conversion light downstream of the reflection surface that is parabolic in section, and the pump light upstream thereof.

The conversion light can then be coupled out from the solid body via a coupling-out surface that is e.g. simultaneously the coupling-in surface for the pump light; by way of example, the solid body therefore has two surfaces that are simultaneously coupling-in surface and coupling-out surface.

In principle, however, by way of example, a surface of the solid body could also be dichroically reflectively coated and so only coupling-in could be effected at said surface and the conversion light could be reflected to a different coupling-out surface. By way of example, the reflection surface that is parabolic in section could also be dichroically reflectively coated, that is to say pump light could be coupled in through the first reflection surface; only the conversion light would then be reflected at said reflection surface, that is to say that the beam shaping device would be used only in a collimating fashion.

The “gathering” of the conversion light as described in the paragraphs above is in general also possible, of course, if the pump light is not supplied by the beam shaping device; specifically, the phosphor element can, for example, also be illuminated “on the rear side”, that is to say at an opposite side relative to the coupling-in surface of the beam shaping device, and can thus be operated in transmission.

The above-described embodiment having one surface, preferably two surfaces used in each case simultaneously for coupling-in and for coupling-out, is nevertheless preferred. In other words, with the beam shaping device, by way of example, pump light emitted by a semiconductor laser diode can be focused onto the phosphor element and the conversion light can then be “gathered” by means of the same beam shaping device; such a beam shaping device may also include a plurality of solid bodies which can be operated in each case with a dedicated semiconductor laser diode.

Various embodiments also generally relate to a beam shaping device having a phosphor element assigned to the coupling-in surface (collimating use for conversion light) and/or the coupling-out surface (focusing use).

The phosphor element may be stationary for example relative to the coupling-in surface, for instance as an areal phosphor element substantially corresponding to the coupling-in surface in terms of its dimensions (“phosphor lamina”); however, the phosphor element may also be moved relative to the coupling-in surface, for example as a rotating body of revolution, that is to say for instance as a “phosphor wheel”, only ever one segment of which is assigned to the coupling-in surface.

Various embodiments relate to the three-dimensional configuration of the beam shaping device, e.g. of the first reflection surface, in a further sectional plane, perpendicular to the previously discussed sectional plane relating to the (parabolic) configuration; said further sectional plane also includes a light propagation direction, e.g. a main propagation direction.

In general, the first reflection surface in the further sectional plane could be a straight line, for example, that is to say that the beam shaping device could be formed by a parallel displacement of the sectional form (of the beam shaping device in section); equally, said sectional form could also be rotated about an axis of rotation in order to form a body of revolution.

The beam shaping device may furthermore also (once again) be embodied in a parabolic fashion in the further sectional plane, wherein, in the case of two parabolas having different focal lengths, the focusing/collimation may differ in the mutually perpendicular sectional planes.

Furthermore, a first reflection surface embodied in an elliptic fashion in the further sectional plane is preferred; in this case, “elliptic” is intended in the extreme also to encompass an ellipse whose focal points coincide, that is to say which has a circular shape.

A corresponding combination (“ellipse+parabolic shape”/“2 parabolas having different focal lengths”/“straight line+parabolic shape”) may, for example, also be of interest in relation to a lighting device (a beam shaping device with light source), specifically if the beam emitted by the light source has an aperture angle of different magnitudes as viewed in two mutually perpendicular beam sectional planes.

One example of such a light source may be a semiconductor laser diode which emits light having an aperture angle of tens of degrees (typically around 25°) in a “fast axis” extending in the direction of the layer thickness of the active medium. In the “slow axis” perpendicular thereto, the aperture angle is significantly smaller, by contrast, and is only a few degrees (typically around 5°).

If the light source and the beam shaping device are arranged with respect to one another in such a way that the beam sectional plane of the larger aperture angle coincides with the sectional plane relating to the parabolic configuration (or the parabola having a shorter focal length), the aperture angles of the beam can in any case be approximated to one another.

If the first reflection surface in the further sectional plane is embodied in a planar fashion (a straight line), for example, the concentration of the light is then altered only in the sectional plane relating to the parabolic configuration. By means of a corresponding adaptation of the beam sectional plane which corresponds to the fast axis, for example, as a result it is therefore possible, for instance, also to achieve a beam having a substantially circular cross-sectional profile.

Various embodiments also relate to a beam shaping device having a plurality of solid bodies (which in general can also be embodied integrally), the coupling-out surfaces of which are tilted relative to their respective coupling-in surface, to be precise by an angle of, e.g. in this order, at least 20°, 30°, 40°, 50°, 60°, 70° or 80° and (independently thereof), e.g. in this order, at most 160°, 150°, 140° or 130°; in this case, the coupling-in surfaces of the plurality of solid bodies are arranged substantially parallel to one another, as are the coupling-out surfaces.

By way of example, if the coupling-in surfaces also lie substantially in one plane, then light can be “gathered” for instance in the case of collimating use of a surface corresponding to the sum of the coupling-in surfaces; alongside the collimation effected by each individual solid body, a substantially collimated “total beam” (sum of the beams) is also achieved by means of the mutually parallel coupling-out surfaces. In this case, the tilting of the coupling-out surfaces relative to the coupling-in surfaces leads to a total beam that is as “closely packed” as possible, that is to say the smallest possible extent of the total beam as regarded perpendicular to the main propagation direction. (For illustration: two mutually parallel rays spaced apart from one another in a plane perpendicular to the ray propagation direction can be brought closer together by being tilted in a common plane by the same angle in the same direction.)

If the light from a plurality of light sources is combined otherwise (without a beam shaping device according to the invention with tilted coupling-in/coupling-out surfaces), complex optical measures may be necessary in order to reduce the total beam cross section perpendicular to the main propagation direction, for example so-called “staircase mirrors”.

Various embodiments also relate very generally to a lighting arrangement, that is to say a beam shaping device described above and below with an assigned light source; the beam shaping device and the light source are then e.g. arranged with respect to one another in such a way that the light propagation in the beam shaping device takes place in a manner described in the context of this disclosure.

“Light source” means an electrically operable source, which may also include a phosphor, for instance a LASER or an LED. The light can be emitted for example by the LED itself and/or by phosphor pumped by the LED; the phosphor (provided directly on the light source) can, for example, be embedded into silicone or a ceramic or else be applied directly. If light source and phosphor are spaced apart from one another, the terms used are “light source” and “phosphor element”.

In various embodiments, a light-emitting surface of the light source (or of a phosphor element) is then assigned to the coupling-in surface of the beam shaping device, wherein coupling-in surface and light-emitting surface with further preference are spaced apart from another by means of a material having a refractive index lower than that of the solid body. Therefore, between coupling-in surface and light-emitting surface an air gap, for example, can be present (the refractive index of air is approximately 1, and that of glass, including synthetic glass, is typically greater than 1.5).

Spacing apart by means of an (air) gap can have the advantage that light emitted by the light-emitting surface in a Lambertian manner (aperture angle +/−90°) into the gap is refracted in the direction of the optical axis by the transition into the optically denser medium (that of the solid body), with the result that a beam having a smaller aperture angle is present after coupling-in (simulations have shown a decrease by at least +/−10°, +/−20° or +/−30°). This is because in so far as the emission characteristic can be described as Lambertian, it manifests this property also independently of the (exact) refractive index of the medium downstream of the light-emitting surface—the lower said refractive index, the less light is emitted, but the Lambertian emission characteristic per se remains unaffected by this.

Therefore, by virtue then of the fact that an air gap, for example, is present between light-emitting surface and solid body, although overall less light is emitted, the light refracted toward the optical axis in the course of transition into the solid body is then already concentrated a little way; in the case of a solid body placed directly onto the light-emitting surface, by contrast, light would be emitted into said solid body in a Lambertian manner, that is to say that the aforementioned beam would be surrounded by “contaminated light” which is possibly not used any further at all.

A beam having a smaller aperture angle (after coupling-in) can be advantageous in so far as the reflection surface that is parabolic in section can also be made smaller as the aperture angle decreases, which can afford advantages with regard to a compact design.

Various embodiments are also directed to a method for operating a beam shaping device or lighting device described in the context of this disclosure, that is to say specifically to a method for beam shaping (focusing and/or collimation), wherein light is coupled into the solid body, reflected therein and subsequently coupled out again.

Furthermore, various embodiments also relate to the use of a corresponding beam shaping device or lighting device for, by way of example, a projection apparatus, an effect light apparatus, a headlight for vehicles or devices for interior lighting.

The optical terms and terms relating to lighting technology as used in this specification, such as light, radiation, emission and beam shaping device, are intended always to relate to the entire electromagnetic spectrum, that is to say e.g. to the ultraviolet, visible and infrared wavelength ranges. Accordingly, the light sources and phosphor arrangements used can emit their radiation in the entire electromagnetic spectrum. In this case, a phosphor element may contain a mixture including a plurality of fluorescent and/or phosphorescent substances. The beam shaping device described here can be embedded into a suitable cooling medium or a suitable immersion liquid.

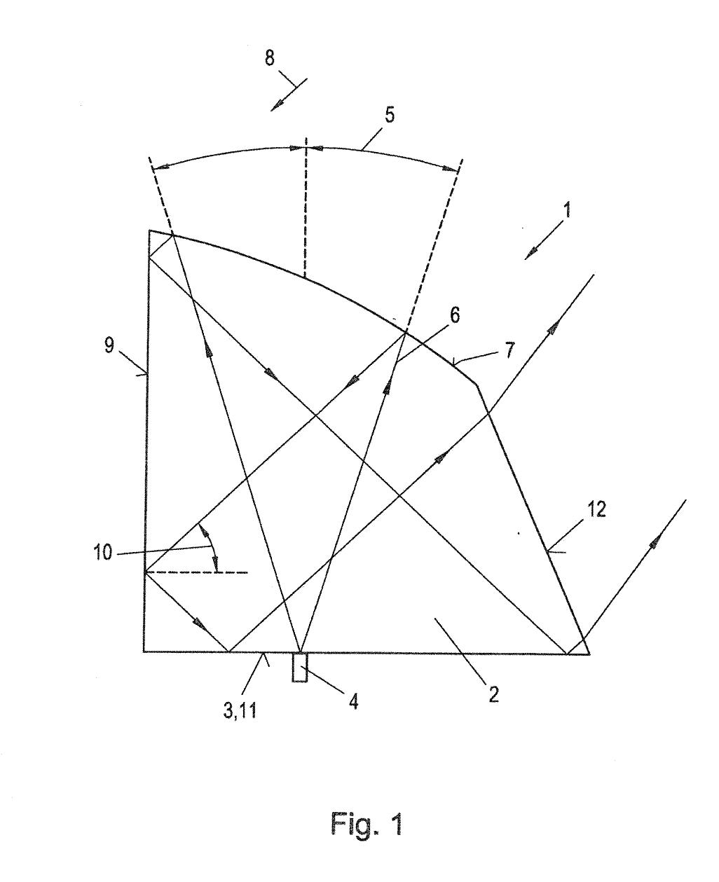

FIG. 1 shows a beam shaping device 1 according to the invention having a solid body 2 composed of glass having a refractive index of n≈1.55. The solid body 2 includes a coupling-in surface 3, at which the light emitted by a light source 4 is coupled into the solid body 2. In the present case, for the sake of clarity, a point source is illustrated which emits divergent light having a specific aperture angle 5; in practice, instead of the punctiform light source 4, an areal light source will often be provided (this being omitted in the present case for reasons of clarity).

In the present case, the punctiform light source 4 could be displaced somewhat toward the left or right in the figure and nothing fundamentally would change as long as the marginal rays 6 bounding the beam still impinge on a first parabolic reflection surface 7; in the present case, therefore an areal light source could also be of corresponding size.

The first reflection surface 7 is reflectively coated with a metal film on the outer side and has a parabolic course (cf. FIG. 4 and FIG. 5; the parabola axis is also illustrated therein) in a sectional plane that includes a main propagation direction 8 and corresponds to the plane of the drawing.

The light source 4 is arranged at the focal point of the parabola, such that the light emitted by it as a divergent beam is collimated by the reflection at the reflection surface 7 that is parabolic in section, and collimated rays parallel to the parabola axis are present downstream of the first reflection surface 7.

Said rays are then reflected at a second reflection surface 9 without alteration of the concentration (the collimation of the beam is maintained), to be precise by total reflection. The angle of incidence is therefore greater than the critical angle (θ_{c} arcsin (n_{surrounding medium}/n_{solid body})).

Downstream of the second reflection surface 9, the beam is reflected at a third reflection surface 11, once again without a change in the concentration and equally by total reflection. The third reflection surface 11 corresponds to the coupling-in surface 3, the double use (coupling-in and reflection) is possible on account of the total reflection, that is to say that no reflective coating is necessary.

Downstream of the third reflection surface 11, the collimated beam is coupled out via a coupling-out surface 12. Since the beam is slightly tilted with respect to the coupling-out surface 12, it is slightly deflected in this case, but the collimation is maintained. (It goes without saying that the coupling-out surface 12 could also be chosen such that it is perpendicular to the beam (relative to the direction thereof before coupling-out), that is to say that the beam is not deflected during coupling-out.)

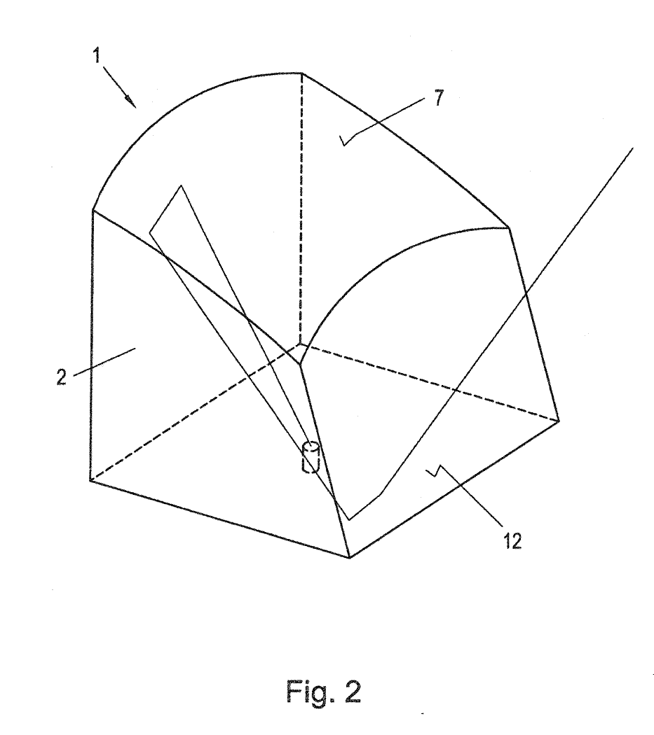

FIG. 2 shows the beam shaping device 1 elucidated in section with reference to FIG. 1 in an oblique view; the sectional plane in accordance with FIG. 1 passes through the solid body 2 centrally and lies parallel to that side surface of the solid body 2 which faces the observer (perpendicular to the coupling-out surface 12, which likewise faces the observer).

The first reflection surface 7, which is parabolic in section (the parabolic shape may also be discerned at the aforementioned side surface facing the observer), is embodied in a circular fashion in a further sectional plane, which likewise includes the main propagation direction 8 and which is perpendicular to the first sectional plane (and parallel to the rear side opposite the coupling-in surface 12 and facing away from the observer). Therefore, the beam is collimated only in one beam sectional plane and, in a beam sectional plane perpendicular thereto, although the aperture angle of said beam is altered, said beam is not collimated. By way of example, a specific beam cross section can be set in this way.

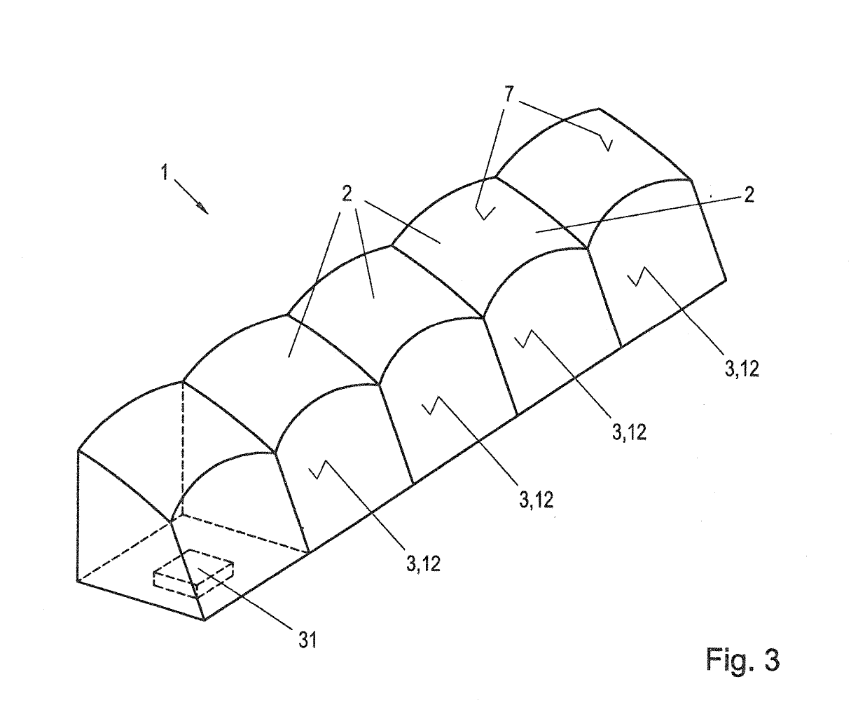

FIG. 3 shows a beam shaping device 1 having a plurality of solid bodies 2 in accordance with FIG, 2 in an oblique view. The solid bodies 2 are provided alongside one another in series and are in each case arranged on a phosphor element 31.

The phosphor element 31 can be operated in transmission, for example, that is to say can be illuminated with pump light at the opposite side to the solid bodies 2 (from below in the figure), and the solid bodies 2 collimate the conversion light, which is then emitted via the coupling-out surfaces 12.

However, pump light can also be coupled in via the coupling-out surfaces 12, such that the latter are therefore simultaneously coupling-in surfaces 3 for the pump light. The pump light coupled in a collimated manner then passes through the beam shaping device 1 in an opposite direction to that for the conversion light (cf. the description concerning FIG. 1) and is focused onto the phosphor element 31 by the parabolic reflection surface 7.

Pump light and conversion light can be separated from one another for example by means of a dichroic mirror situated opposite the coupling-out/coupling-in surfaces 3, 12.

FIG. 4 and FIG. 5 are based on a simulation (using the software “LightTools”) and illustrate the fact that with a beam shaping device 1 according to various embodiments a collimation (or focusing) is possible even when the light source 4 (or a phosphor element onto which focusing is intended to be effected) is not arranged directly at the focal point.

In order to illustrate the course of the parabola, the illustrations in each case show the parabola axis 41 and a coordinate axis 42 perpendicular thereto, a tangent to the vertex point 43 of the parabola (usually designated as the “x-axis” in mathematics), in a dash-dotted manner.

In the case of the embodiment in accordance with FIG. 4, the light source 4 is offset a little way relative to the parabola axis 41 (and thus necessarily relative to the focal point of the parabola)—therefore, the beam does not run parallel to the parabola axis 41 after reflection; however, the simulation results show at least collimated rays. Therefore, despite the light source 4 offset relative to the focal point, the beam is sufficiently collimated (and, conversely, it could also be focused onto a phosphor element not arranged at the focal point).

In the case of the embodiment in accordance with FIG. 5, the light source 4 is moved in comparison even further from the focal point and the rays reflected at the parabolic reflection surface 7 are accordingly tilted to an even greater extent relative to the parabola axis 41. Nevertheless, the beam per se is once again sufficiently collimated (that is to say that the rays reflected at the reflection surface 7, even though they are not substantially parallel to the parabola axis 41, are nevertheless substantially parallel to one another).

The device as described above in accordance with various embodiments may be used for at least one of a projection apparatus, an effect light apparatus, a headlight for vehicles and a device for interior lighting.

While the invention has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

What is claimed is:

1. A device for the beam shaping of light, the device comprising:
a solid body composed of a transmission material that is at least partly transmissive to the light, the solid body comprising:
a coupling-in surface for coupling in the light,
a first reflection surface for deflecting the light, and
a coupling-out surface for coupling out the light,
wherein the solid body is designed to reflect the coupled-in light in its interior at the first reflection surface; and
wherein the first reflection surface is embodied in a parabolic fashion in a sectional plane including a propagation direction of the reflected light.

2. The beam shaping device as claimed in claim 1,
wherein the first reflection surface is reflectively coated on the outer side.

3. The beam shaping device as claimed in claim 1, further comprising:
having a second reflection surface which is designed to reflect the coupled-in light without changing its concentration, e.g. by total reflection.

4. The beam shaping device as claimed in claim 3, further comprising:
a third reflection surface, which is designed to reflect the coupled-in light without changing its concentration.

5. The beam shaping device as claimed in claim 4,
wherein the third reflection surface is designed to reflect the coupled-in light without changing its concentration by total reflection.

6. The beam shaping device as claimed in claim 4,
wherein, in the direction of light propagation, the second reflection surface and the third reflection surface are disposed downstream of the reflection surface configured in a parabolic fashion in the sectional plane and the third reflection surface coincides with the coupling-in surface.

7. The beam shaping device as claimed in claim 4,
wherein the second reflection surface and the third reflection surface are disposed upstream of the reflection surface embodied in a parabolic fashion in the sectional plane and the third reflection surface coincides with the coupling-out surface.

8. The beam shaping device as claimed in claim 1,
wherein the coupling-in surface is at the same time also the coupling-out surface.

9. The beam shaping device as claimed in claim 1,
wherein the reflection surface embodied in a parabolic fashion in the sectional plane is embodied as one of parabolic and elliptic as viewed in a further sectional plane, lying perpendicular to the sectional plane relating to the parabolic configuration.

10. The beam shaping device as claimed in claim 1,
comprising a plurality of solid bodies, each solid body comprising:
a coupling-in surface for coupling in the light,
a first reflection surface for deflecting the light, and
a coupling-out surface for coupling out the light,
wherein the coupling-out surface of each solid body is tilted with respect to the coupling-in surface thereof, to be precise by an angle of at least 20° and at most 160°, wherein the coupling-in surfaces and the coupling-out surfaces of the plurality of solid bodies are in each case arranged substantially parallel to one another.

11. A lighting device, comprising:
a beam shaping device, comprising:
a solid body composed of a transmission material that is at least partly transmissive to the light, the solid body comprising:
a coupling-in surface for coupling in the light,
a first reflection surface for deflecting the light, and
a coupling-out surface for coupling out the light,
wherein the solid body is designed to reflect the coupled-in light in its interior at the first reflection surface; and
wherein the first reflection surface is embodied in a parabolic fashion in a sectional plane including a propagation direction of the reflected light; and
a phosphor element assigned to at least one of coupling-in and coupling-out surfaces.

12. The lighting device as claimed in claim 11, further comprising:
a light source.

13. The lighting device as claimed in claim 12,
wherein the light-emitting surface of one of light source and phosphor element is assigned to the coupling-in surface of the solid body.

14. The lighting device as claimed in claim 13,
wherein the light-emitting surface of one of light source and phosphor element is spaced apart from the coupling-in surface of the solid body, to be precise by means of a material having a refractive index lower than that of the solid body.

15. The lighting device as claimed in claim 13,
wherein a beam emitted by the light source has an aperture angle of different magnitudes as viewed in two mutually perpendicular beam sectional planes, wherein the light source and the solid body are arranged with respect to one another in such a way that the beam sectional plane with the larger aperture angle coincides with the sectional plane relating to the parabolic configuration.

16. A method for the beam shaping of light with a beam shaping device,
the beam shaping device comprising:
a solid body composed of a transmission material that is at least partly transmissive to the light, the solid body comprising:
a coupling-in surface for coupling in the light,
a first reflection surface for deflecting the light, and
a coupling-out surface for coupling out the light,
wherein the solid body is designed to reflect the coupled-in light in its interior at the first reflection surface; and
wherein the first reflection surface is embodied in a parabolic fashion in a sectional plane including a propagation direction of the reflected light;
the method comprising:
coupling light into the coupling-in surface of the solid body;
reflecting the coupled-in light at the reflection surface embodied in a parabolic fashion in the sectional plane; and
coupling the reflected light out at the coupling-out surface.

17. A method for the beam shaping of light with a lighting device,
the lighting device comprising:
a beam shaping device, comprising:
a solid body composed of a transmission material that is at least partly transmissive to the light, the solid body comprising:
a coupling-in surface for coupling in the light,
a first reflection surface for deflecting the light, and
a coupling-out surface for coupling out the light,
wherein the solid body is designed to reflect the coupled-in light in its interior at the first reflection surface; and
wherein the first reflection surface is embodied in a parabolic fashion in a sectional plane including a propagation direction of the reflected light; and
a phosphor element assigned to at least one of coupling-in and coupling-out surfaces;
the method comprising:
coupling light into the coupling-in surface of the solid body;
reflecting the coupled-in light at the reflection surface embodied in a parabolic fashion in the sectional plane; and
coupling the reflected light out at the coupling-out surface.
